(19) United States
(12) Patent Application Publication
(10) Pub. No.: US 2006/0208527 A1
(43) Pub. Date: Sep. 21, 2006

(54) Door handle and closing system for the door of a vehicle

(76) Inventors: Uwe Freyholdt, Giengen (DE); Michael Geber, Bad Urach (DE); Karl-Juergen Peters, Gaeufelden (DE); Andreas Pohlmann, Weil der Stadt (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/541,868

(22) PCT Filed: Nov. 25, 2003
(86) PCT No.: PCT/EP03/13219

§ 371 Date: Apr. 13, 2006

(30) Foreign Application Priority Data
Jan. 10, 2003 (DE) 103 00 572.2

(51) Int. Cl. B60J 5/00

(52) U.S. Cl. 296/146.1

(57) ABSTRACT

A door handle is mounted on the outside of a vehicle door in a deflectable fashion, and a sensor for detecting a manual deflection of the door handle relative to the vehicle door is arranged in the door handle. It is possible to trigger a vehicle function electrically with the door handle when a predefined deflection value for the door handle is reached. These measures make access to a vehicle comfortable and reliable.

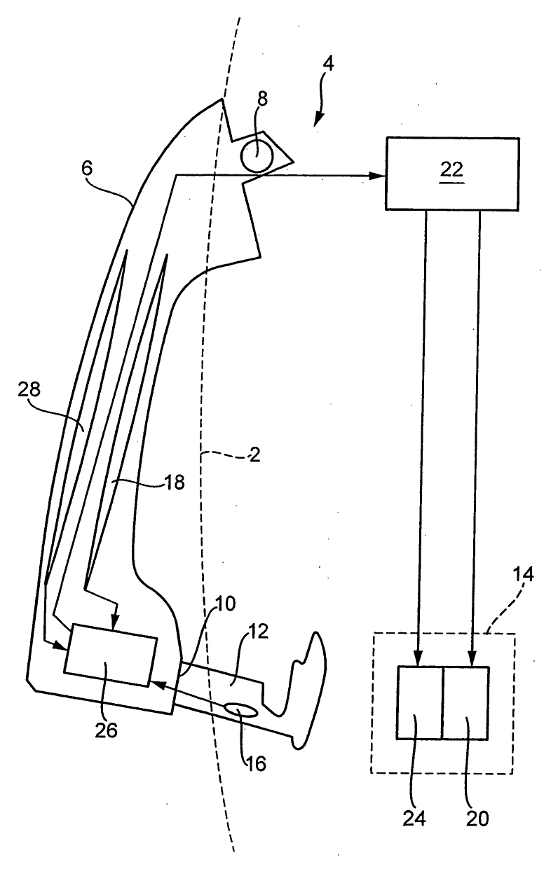

### BACKGROUND AND SUMMARY OF THE INVENTION

This invention relates to a door handle and to a closing system for a vehicle door.

In the development of vehicles particular attention is paid to the operation and the functionality of the vehicle access devices, in particular the handle arrangements.

Such a handle arrangement for a motor vehicle is known, for example, from German document DE 100 57 019 A1. A door handle which is arranged on an outside of a door is pivotably mounted on a carrier part which is arranged in the interior of the door. Furthermore, the door handle has a driving element which, during an opening movement of the door handle of the interior of the door, activates a release handle of a door lock which is arranged in the door in order to open said lock.

Furthermore, German document DE 196 17 038 C2 describes a closing system and vehicle authorization system in which at least one electrode is installed in the grip parts of the door handles and a counterelectrode, which may also be the door per se, is mounted in the part of the door lying opposite the grip part. If an electrical field is built up between the two electrodes, said field may advantageously be used to sense the desire of a person who is gripping a door handle to access the vehicle. This is done by a hand which moves towards one of the grip parts located on the doors, bringing about a change in the capacitance built up between the two electrodes even as the hand approaches. An electronic system which perceives the change in the capacitance and converts it into a command pulse is contained in a space-saving fashion in the grip part of the door handle. The command pulse which is generated by this electronic system triggers the interrogation of a data carrier in the electrical control unit. The closing system can be locked by a second sensor or momentary contacts which are arranged on the grip part. The vehicle is secured by brushing a hand in front of the sides of the grip part facing away from the vehicle. The locking and unlocking processes of the vehicle are thus made pleasant and comfortable for a person who is authorized to access the vehicle.

In DaimlerChrysler vehicles, an electronic driving authorization system with the name KEYLESS-GO is also used, said system operating without mechanical or electronic keys. Its functions are performed by a thin chip card in the format of a conventional EC or credit card. The advantage here is that before getting into a vehicle car drivers do not have to hold their key or the card in their hand, and the keys or cards may remain in the shirt pocket or jacket pocket. The door handles are equipped with contact-sensitive sensors and the lid of the trunk is equipped with a specific pushbutton key. As soon as the driver touches a door handle or activates momentary contacts which are on the rear of the vehicle, his chip card receives signals from inductive antennas which are accommodated in the doors and in the rear bumper of the vehicle. In response, the card sends an identification code to the vehicle by radio. If said code corresponds to the stored value, the owner of the vehicle can get in immediately or open the trunk lid. The inductive data transfer lasts only a few fractions of a second. In order to secure the vehicle after the person gets out it is sufficient to press a key on the door handle or on the lid of the trunk in order to activate the inductive antennas. The system immediately exchanges data again with the chip card and then secures the vehicle, said data being stored for later unlocking processes.

The present invention is then based on the object of making the access to a vehicle more comfortable and reliable.

The object is achieved by means of a door handle and by means of a closing system for a vehicle door as claimed.

According to the invention, a sensor for detecting a manual deflection of the door handle relative to a vehicle door is arranged in a door handle, it being possible to trigger a vehicle function electrically with said door handle when a predefined deflection value for the door handle is reached. It is sufficient to reach for the door handle and slightly pull on it in order to activate the electrically triggerable vehicle function. A predefined deflection of the door handle, for example by 1 cm with respect to its position of rest, is sufficient as a triggering moment for the vehicle function. All those vehicle functions which make it easier for a person with access authorization to get into a vehicle may be electrically triggerable vehicle functions. When a person gets into a motor vehicle the vehicle function may comprise, for example, a comfort opening function which permits the person with access authorization to get in with only a small expenditure of mechanical force.

In the case of a closing system with such a door handle, the vehicle function which can be triggered by the deflection of the door handle is a closing system function, in particular a rapid unlocking function. In this context, the unlocking of the vehicle door is not performed by a central locking system which could prove too slow when making an attempt to open the doors quickly. During an opening phase of the central locking system which follows the unlocking phase the vehicle door would still be unlocked and could not be opened in the opening phase. With the present configuration of the closing system the vehicle door can be unlocked and opened in one movement process. Occasions when it is futile to pull on the door handle in order to selectively open the vehicle door because the vehicle door is still locked are avoided. The vehicle door is reliably unlocked before it is actually opened independently of the opening speed. During the opening phase, the vehicle door can jump out of its closed position into a slightly opened position owing to mechanical prestressing of the door. The access-authorized person then only needs to pivot the vehicle door to the position desired by him. It is possible to dispense completely with the use of additional pushbutton switches and pull switches. It is also unnecessary to take measures to seal the operating panels to be activated since the sensor is located in the internal region of the door handle and cannot be seen from the outside. It is thus completely protected against soiling. The present closing system proves extremely comfortable and user-friendly as a result of a time advantage for an opening and a simplified functionality.

In one refinement, in which the door handle has, at one of its ends, a driving element which activates a door lock arranged in the interior of the vehicle door when there is an opening movement of the door handle, it is advantageous if the sensor is arranged in the region of the driving element. In the closed state of the vehicle door the sensor is located in the internal region of the vehicle door, in particular in the internal region of the door lock which is assigned to the respective vehicle door. This permits the sensing of the deflection of the door handle to be implemented in a particularly simple way.

In this context it is advantageous if a servomotor in the door lock assigned to the vehicle door is actuated in order to quickly unlock the door lock. The servomotor ensures prompt unlocking of the vehicle door.

Further advantageous embodiments of the invention are also claimed.

### BRIEF DESCRIPTION OF THE DRAWINGS

The invention will be explained in more detail by reference to an exemplary embodiment in the single FIGURE, with the FIGURE showing a detail of a vehicle door with a closing system in a schematic illustration.

### DETAILED DESCRIPTION OF THE INVENTION

The detail of a vehicle which is illustrated in the FIGURE shows a partially illustrated vehicle door 2 with a closing system 4 which comprises a door handle 6 which is mounted on the outside of the vehicle door 2. The door handle 6 is pivotably mounted at one of its ends 8 and has at its other end 10 a driving element 12 which, when there is an opening movement of the door handle 6, activates a door lock 14 which is arranged in the interior of the vehicle door 2 and indicated in the FIGURE. A sensor 16 for detecting a deflection of the door handle 6 which has occurred relative to the vehicle door 2 is arranged in the region of the driving element 12, the deflection being brought about manually by a person with access authorization. In alternative exemplary embodiments (not illustrated in more detail), the sensor 16 may also be accommodated in other regions of the door handle 6, in particular in the central region of the door handle 6, it being possible for the door handle 6 itself to have other embodiments with differently configured deflection mechanisms.

The sensor 16 is embodied as a capacitive sensor, as a Hall sensor, as a reed contact or as an acceleration sensor. In the case of the acceleration sensor, the distance of the deflection of the door handle 6 is determined by double integration over time over the acceleration of the door handle 6 occurring when the vehicle door 2 opens.

In addition, a capacitive unlocking sensor 18 for unlocking the vehicle door 2 by means of a central locking system 22 may be arranged in the region of the door handle 6, in particular in the region facing the door. When a person with access authorization reaches with his hand in a natural fashion in order to open the vehicle door 2 his hand reaches behind the door handle 6 and moves into the sensitive area of the capacitive unlocking sensor 18. The unlocking sensor 18 detects the hand and firstly triggers, in a known fashion, an identification code interrogation in an access authorization system, during which identification code interrogation an inductive data transfer takes place between the vehicle and a chip card carried along by the person with access authorization. After a positive identification code interrogation has taken place, a conventional unlocking function 20 of the vehicle is automatically triggered by means of the central locking system 22.

In order to open the vehicle door 2, the door handle 6 is deflected by the person with access authorization after he has gripped behind the door handle. When the vehicle door 2 is reached for quickly, the unlocking process using the central locking system 22 often takes place too slowly for technical reasons so that when an attempt is made to open the door quickly in a selective fashion the vehicle door 2 is not yet unlocked and can be released for opening.

If the central locking system 22 has not released the vehicle door 2 when a predefined deflection value for the door handle 6 is reached, the sensor 16 releases a rapid unlocking function 24 in the door lock 14 of the vehicle door 2. In order to unlock the vehicle door 2 rapidly, a servomotor is provided and is arranged in the door lock 14. The sensor 16 actuates the servomotor arranged in the door lock 14 by means of a control unit 26 which is integrated into the door handle 6 and by means of the central locking system 22, and said sensor activates the rapid unlocking function 24.

The triggering of the rapid unlocking function 24 of the vehicle door 2 when the predefined deflection value for the door handle 8 is reached takes place within a predefined time period after the unlocking sensor 18 has been activated. This ensures that even when the motor vehicle is opened rapidly in a selective fashion the vehicle door 2 is actually unlocked before the actual opening takes place. This prevents the door handle 6 from being pulled down “empty” by the person with access authorization since unlocking pins have not yet been disengaged and the vehicle door 2 does not open mechanically released. For slow opening processes of the vehicle door 2, i.e. the predefined deflection value for the door handle 6 is not reached until after the predefined time period has expired, the unlocking process is carried out by means of the central locking system 22 with the conventional unlocking function 20. For a normal operating mode in which relatively slow opening processes predominantly occur it is not necessary to use the rapid unlocking function 24. A required reaction time from the pulling of the door handle 6 to the unlocking by the servomotor is less than 300 ms.

When an acceleration sensor is used as a sensor 16 for detecting a manual deflection of the door handle 6 relative to the vehicle door 2, instead of or in addition to the deflection of the door handle 6 it is also possible to accelerate the door handle 6 itself and/or its average speed, determined by simple integration over time over the acceleration of the door handle 6 occurring when the vehicle door 2 is opened, as a criterion for when a predefined deflection value is reached, and thus as a triggering criterion for the rapid unlocking function 24, for example. For the average speed and/or for the acceleration it is possible to specify a lower threshold value, with the rapid unlocking function 24 being activated only above this low threshold value.

The rapid unlocking function 24 which is triggered by means of the sensor 16 ensures reliable and rapid opening of the vehicle door 2 independently of the reaction time of the pneumatics/mechanics of the central locking system 22.

In addition, a capacitive locking sensor 26 for locking the vehicle door 2 may be arranged in the region of the door handle 6 facing away from the door. Alternatively, this locking sensor 26 and/or the unlocking sensor 18 may be embodied as momentary contact switches. The control unit 26 is actuated both by the sensor 16 and also by the unlocking sensor 18 and/or the locking sensor 28. The control unit 26 thus processes all the sensor signals sensed in the door handle 6. In an exemplary embodiment which is not illustrated further, the unlocking sensor 18 is dispensed with and the vehicle door 2 is unlocked solely by means of the sensor 16.

The closing system 4 with the door handle 6 and the sensor 16 of whatever design may comprise other closing system functions, in particular a comfort opening function, in addition to or instead of the rapid unlocking function 24. For example a virtually self-opening process of the vehicle door 2 is provided for the person with access authorization, during which opening operation a mechanism which is integrated into the door lock 14 which is assigned to the respective vehicle door 2 opens the driving element 12 of the door handle 6 for a virtually self-opening process of the vehicle door 2 when the predefined deflection value for the door handle 6 is reached. With this embodiment of the closing system 4, the vehicle door 2 can be opened without overcoming a mechanical resistance due to the lock. The vehicle door 2 jumps toward the person with access authorization owing to its mechanical prestress or is pushed out of its closed position with the assistance of a motor. During manual opening movements at low speed, the comfort opening function may be suspended, for example, in order to permit conventional opening of the door, for example for test purposes or if the comfort opening function fails.

When the predefined deflection value is reached it is also possible to use the door handle 6 itself to trigger electrically other vehicle functions which do not include the functional range of the closing system 4. These include only the activation of an air-conditioning control system, in particular a seat air-conditioning control system or the opening of a sun roof. It is also conceivable to switch on illuminating devices in the interior or in the exterior region of a motor vehicle as a function of further parameters such as daylight or ambient lighting.

The door handle 6 or the closing system 4 according to the invention ensures a rapid, reliable and comfortable opening of the motor vehicle. Unsuccessful manual operation of the door handle 6 is prevented. Furthermore, by means of the door handle 6 it is possible to actuate various vehicle and closing system functions which simplify a driving-off phase of the motor vehicle in terms of operator control and at the same time make it more comfortable for the driver.

1-11. (canceled)

12. A closing system comprising:
a door handle which is mounted on an outside of a vehicle door in a deflectable fashion, and
a sensor for detecting a manual deflection of the door handle relative to the vehicle door arranged in the door handle,
wherein it is possible to trigger a vehicle function electrically with said door handle when a predefined deflection value for the door handle is reached, and
wherein the vehicle function which can be triggered by the deflection of the door handle is a rapid unlocking function in which a servomotor in a door lock assigned to the vehicle door is actuated in order to rapidly unlock the door lock.

13. The closing system as claimed in claim 12, wherein the door handle has at one end a driving element which activates a door lock arranged in the interior of the vehicle door when there is an opening movement of the door handle, and the sensor is arranged in the region of the driving element.

14. The closing system as claimed in claim 12, wherein the sensor is a capacitive sensor, a Hall sensor, a reed contact or an acceleration sensor.

15. The closing system as claimed in claim 12, and further comprising an unlocking sensor for unlocking the vehicle door arranged in a region of the door handle.

16. The closing system as claimed in claim 15, wherein the unlocking sensor for unlocking the vehicle door is arranged in the region of the door handle facing the door.

17. The closing system as claimed in claim 15, wherein the locking sensor for locking the vehicle door is arranged in another region of the door handle facing away from the door.

18. The closing system as claimed in claim 15, wherein at least one of the unlocking sensor and the locking sensor is a capacitive sensor.

19. The closing system as claimed in claim 12, wherein a control unit which can be actuated by the sensor in order to detect manual deflection is integrated into the door handle.

20. The closing system as claimed in claim 19, wherein the control unit can be additionally actuated by at least one of the unlocking sensor and the locking sensor.

21. The closing system as claimed in claim 15, wherein triggering of the rapid unlocking function when the predefined deflection value for the door handle is reached can take place within a predefined time period after the activation of the unlocking sensor.

22. The closing system as claimed in claim 20, wherein the closing system performs a comfort opening function in which a mechanism in the door lock assigned to the vehicle door opens the driving element of the door handle for a virtually self-opening process of the vehicle door.
